(19) United States
(12) Patent Application Publication
(10) Pub. No.: US 2026/0253946 A1
(43) Pub. Date: Aug. 27, 2026

(54) MULTI-DOPED GARNET ELECTROLYTES

(71) Applicant: ION STORAGE SYSTEMS, INC., Beltsville, MD (US)

(72) Inventors: Dennis McOwen, Beltsville, MD (US); Patrick STANLEY, Beltsville, MD (US); Alireza PESARAN, Beltsville, MD (US)

(21) Appl. No.: 18/875,882

(22) PCT Filed: Jun. 27, 2023
(86) PCT No.: PCT/US2023/069135

§ 371 Date: Dec. 17, 2024

Related U.S. Application Data
(60) Provisional application No. 63/356,890, filed on Jun. 29, 2022.

(51) Int. Cl. H01M 10/0562; H01M 10/052

(52) U.S. Cl. CPC H01M 10/0562; H01M 10/052; H01M 2300/008

(57) ABSTRACT

In one aspect, the present invention provides a solid-state electrolyte material. The solid-state electrolyte material comprises a composition of Formula (I), (II), (III), (IV), (V), (VI), (VII), and/or (VIII), as described herein. Another aspect provides a method of making a green body. A further aspect provides a method of making a sintered solid-state electrolyte material.

### CROSS-REFERENCE TO RELATED APPLICATIONS

This application claims the benefit of U.S. Provisional Application No. 63/356,890, filed on Jun. 29, 2022, the disclosure of which is incorporated herein by reference in its entirety.

### GOVERNMENT LICENSE RIGHTS

This invention was made with government support under contract no. SP4701-20-F-0115 awarded by the Defense Logistics Agency. The U.S. government has certain rights in the invention.

### FIELD OF THE INVENTION

The present disclosure relates to solid-state electrolyte materials suitable for use in solid-state lithium batteries.

### BACKGROUND

Solid-state lithium batteries are made by replacing the highly flammable and unstable liquid electrolytes in conventional lithium-ion batteries. Solid-state electrolyte materials can have numerous advantages over liquid electrolyte materials. For example, solid-state electrolyte materials may be non-flammable, stable at high temperatures without degradation, and electrochemically stable to lithium metal and/or high voltage cathodes. With this improved stability, solid-state batteries can exhibit higher energy and power densities that permit the use of desirable electrode materials otherwise precluded from use with liquid electrolytes.

An ideal solid-state electrolyte material exhibits a combination of several properties. For example, ideal solid-state electrolyte materials may exhibit high ionic conductivity, low/negligible electronic conductivity, high chemical and electrochemical stability, resistance to lithium dendrite propagation, and efficient, low-cost manufacturability. For oxide-type solid-state electrolyte materials, this requires that the material is lightweight, contains little or no secondary phases (i.e., phases other than cubic phase garnet), is capable of manufacture with low or no porosity, and is capable of sintering at lower temperatures in shorter periods of time. The presence of porosity in the separator layer of a battery cell may be detrimental to the electrochemical performance of the cell and/or battery because pores serve as possible pathways for lithium dendrites to propagate through the solid-state electrolyte material, causing a short circuit. Similarly, secondary phases may not have the same chemical or electrochemical stability as the primary phase (i.e., cubic garnet phase) of the solid-state electrolyte material. For this reason, secondary phases may react with active electrode materials during cell cycling and become electronically conductive, causing a short circuit.

Lithium lanthanum zirconium oxide (LLZO) has been recognized as a solid-state electrolyte material having the potential to combine the many desirable properties for a solid-state electrolyte material to be used in a battery. When processed appropriately, LLZO has high Li⁺ ion conductivity (>10⁻⁵ S/cm), low electronic conductivity (~10⁻⁸ S/cm), and is both chemically and electrochemically stable to lithium metal. However, LLZO is challenging to manufacture into a low porosity solid body free of detrimental secondary phases. Typically, LLZO sintering is performed at high temperatures (e.g., 1200° C.), for long periods of time (e.g., 6 hours or more), and in the presence of excess lithium to offset lithium loss. The lithium loss is due to the volatility of lithium at high temperatures.

Accordingly, there remains a need to provide improved solid-state electrolyte materials.

### SUMMARY OF THE INVENTION

The present invention provides a solid-state electrolyte material comprising a composition of Formula (I):

M1₇₋ₓD1ₐM2_{3-y}D2_{b}M3_{2-z}D3_{c}O_{12-w}D4_{d} (I),

wherein:
M1 is Li;
M2 is La;
M3 is Zr;
D1 is H, Be, B, Al, Fe, Zn, Ga, Ge, or any combination thereof;
D2 is Na, K, Ca, Rb, Sr, Y, Ag, Ba, Bi, Pr, Nd, Pm, Sm, Gd, Tb, Dy, Ho, Er, Tm, Zn, Ce, or any combination thereof;
D3 is Mg, Si, Sc, Ti, V, Cr, Mn, Co, Ni, Cu, Ge, As, Se, Nb, Mo, Tc, Ru, Rh, Pd, Cd, In, Sn, Sb, Hf, Ta, W, Ir, Pt, Au, Hg, Tl, Pb, Ce, Eu, Te, Y, Sr, Ca, Ba, Gd, Ge, or any combination thereof;
D4 is F, Cl, Br, I, S, Se, Te, N, P, or any combination thereof;
0≤w≤2;
−0.5<x≤3;
0≤y≤3;
0≤z≤2;
0≤a≤2;
0≤b≤3;
0≤c≤2; and
0≤d≤2,
   wherein at least one of a, b, c, and d is not zero.

In some embodiments, 0<y≤3, 0<z≤2, 0<a≤2, and 0<b≤3, and 0<c≤2. In some embodiments, 0≤w≤1. In other embodiments, 0≤w≤0.5. And, in some embodiments, 0≤w≤0.1.

In some embodiments, 0≤x≤1. In other embodiments, 0.2≤x≤0.8.

In some embodiments, 0<y<3. In other embodiments, 0<y<1. In some embodiments, 0<y<0.5. And, in some embodiments, 0.05≤y≤0.25.

In some embodiments, 0<a≤1. In other embodiments, 0<a<0.24.

In some embodiments, 0<b<3. In other embodiments, 0<b<1. In some embodiments, 0<b<0.5. And, in some embodiments, 0.05≤b≤0.25.

In some embodiments, 0<c≤0.7. In other embodiments, 0<c≤0.5. And, in some embodiments, 0.2≤c≤0.5.

In some embodiments, 0≤d≤1. In other embodiments, 0≤d≤0.5. And, in some embodiments, 0≤d≤0.1.

In some embodiments, D1 is Al, Fe, Zn, and Ga, or any combination thereof. For example, D1 may be Al. In other embodiments, D1 is Fe. In some embodiments, D1 is Zn. And, in some embodiments, D1 is Ga.

In some embodiments, D2 is Ca, Sr, Ba, Bi, and Nd, or any combination thereof. For example, D2 may be Ca. In some embodiments, D2 is Sr. In other embodiments, D2 is Ba. In some embodiments, D2 is Bi. And, in some embodiments, D2 is Ba.

In some embodiments, D3 is Ta, Nb, W, Ti, and Mo, or any combination thereof. For example, D3 may be Ta. In some embodiments, D3 is Nb. In other embodiments, D3 is W. In some embodiments, D3 is Ti. And, in some embodiments, D3 is Mo.

In some embodiments, 7−x=7−a(vD1)+b(3−vD2)+c(4−vD4)−d/2, wherein vD1 is an oxidation state of D1, vD2 is an oxidation state of D2, and vD3 is an oxidation state of D3; D4 is F, Cl, Br, I, or any combination thereof; y=b; z=c; and w=d. In some embodiments, 0≤x≤1.0.

Another aspect of the present invention provides a solid-state electrolyte material comprising a composition of Formula (II):

Li₇₋ₓD1ₐLa_{3-y}D2_{b}Zr_{2-z}D3_{c}O_{12-w}D4_{d} (II),

wherein:
D1 is H, Be, B, Al, Fe, Zn, Ga, Ge, or any combination thereof;
D2 is Na, K, Ca, Rb, Sr, Y, Ag, Ba, Bi, Pr, Nd, Pm, Sm, Gd, Tb, Dy, Ho, Er, Tm, Zn, Ce, or any combination thereof;
D3 is Mg, Si, Sc, Ti, V, Cr, Mn, Co, Ni, Cu, Ge, As, Se, Nb, Mo, Tc, Ru, Rh, Pd, Cd, In, Sn, Sb, Te, I, Hf, Ta, W, Ir, Pt, Au, Hg, Tl, Pb, Ce, Eu, Te, Y, Sr, Ca, Ba, Gd, Ge, or any combination thereof;
D4 is F, Cl, Br, I, S, Se, Te, or any combination thereof;
0≤w<2;
−0.5<x≤3;
0<y≤3;
0<z≤2;
0<a≤2;
0<b≤3; 0<c≤2; and
0≤d≤2.

In some embodiments, 0≤w≤1. In other embodiments, 0≤w≤0.5. And, in some embodiments, 0≤w≤0.1.

In some embodiments, 0<x≤1.5. In some embodiments, 0.5<y≤2. And, in some embodiments, 0.5<z≤1.5.

In some embodiments, 0<a<0.24. In some embodiments, 0<b≤2. And, in some embodiments, 0<c≤1.5.

In some embodiments, 0≤d≤1. In other embodiments, 0≤d≤0.5. And, in some embodiments, 0≤d≤0.1.

In some embodiments, D1 is Al or Ga. For example, D1 may be Al. In other embodiments, D1 is Ga.

In some embodiments, D2 is Ca, Sr, Ba, or any combination thereof. For example, D2 may be Ca. In other embodiments, D2 is Sr. And, in some embodiments, D2 is Ba.

In some embodiments, D3 is Ta, Nb, W, Ti, Mo, or any combination thereof. For example, D3 may be Ta. In some embodiments, D3 is Nb. In other embodiments, D3 is W. In some embodiments, D3 is Ti. And, in some embodiments, D3 is Mo.

In some embodiments, D4 is F, Cl, or any combination thereof. For example, D4 may be F. In other embodiments, D4 may be Cl.

In some embodiments, 0<a≤0.25. In some embodiments, 0<b≤0.5. In some embodiments, 0<c≤1.0. And, in some embodiments, 0≤d≤0.25.

In some embodiments, 0≤x≤1.0. In some embodiments, 0≤y≤0.5. In some embodiments, 0≤z≤1.0. And, in some embodiments, 0≤w≤0.25.

In some embodiments, 7−x=7−a(vD1)+b(3−vD2)+c(4−vD4)−d/2, wherein vD1 is an oxidation state of D1, vD2 is an oxidation state of D2, and vD3 is an oxidation state of D3; D4 is F, Cl, Br, I, or any combination thereof; y=b; z=c; and w=d. In some embodiments, 0≤x≤1.0.

Another aspect of the present invention provides a solid-state electrolyte material comprising a composition of Formula (IV):

LiₙBₓ^{vB}La_{3-y}C_{y}^{vC}Zr_{2-z}D_{z}^{vD}O₁₂₋ₐGₐ (IV),

wherein:
n=7−x(vB)+y(3−vC)+z(4−vD)−a/2, wherein vB is an oxidation state of B, vC is an oxidation state of C, and vD is an oxidation state of D;
B is H⁺, Al³⁺, Ga³⁺, Fe³⁺, Zn²⁺, Ge⁴⁺, or any combination thereof;
C is Ca²⁺, Ba²⁺, Sr²⁺, Mg²⁺, Rb⁺, Ce⁴⁺, or any combination thereof;
D is Ta⁵⁺, Y³⁺, Mo⁶⁺, Nb⁵⁺, W⁶⁺, Ge⁴⁺, Ti⁴⁺, or any combination thereof;
G is F⁻, Cl⁻, Br⁻, I⁻, or any combination thereof;
0<x<0.24;
0<y≤1.0;
0<z≤1.0; and
0≤a≤1.0.

In some embodiments, B is Al³¹. In some embodiments, C is Ca²⁺. In some embodiments, D is Ta⁵⁺, Nb⁵⁺, Ti⁴⁺, or any combination thereof. And, in some embodiments, D is Ta⁵⁺.

In some embodiments, 0<x<0.15. In other embodiments, 0.02<x<0.10.

In some embodiments, 0<y<0.50. In other embodiments, 0.1<y<0.30. And, in some embodiments, 0.15<y<0.28.

In some embodiments, 0<z<0.70. In other embodiments, 0.3<z<0.6. And, in some embodiments, 0.4<z<0.55.

In some embodiments, 0≤a<0.1. In other embodiments, 0≤a<0.05. And, in some embodiments, x, y, z, and a are selected such that 6≤n≤7.

In one aspect, the present invention provides a solid-state electrolyte material comprising a composition of Formula (V):

Li₇₋ₓBₐLa_{3-y}C_{b}Zr_{2-z}D_{c}O₁₂ (V),

wherein:
B is Al or Ga;
C is Ca, Sr, Ba, or Mg;
D is Ta, Nb, W, Mo, or Ti;
0≤x≤1;
0<a<0.24;
0<y≤0.5;
0<b≤0.5;
0<z≤1; and
0<c≤1.

Another aspect of the present invention provides a solid-state electrolyte material comprising a composition of Formula (VI):

Li_{7+y-z}La_{3-y}Ca_{y}Zr_{2-z}Ta_{z}O₁₂ (VI),

wherein:
0<y<0.3; and
0.2<z<0.6.

In another aspect, the present invention provides a solid-state electrolyte material comprising a composition of Formula (VII):

Li_{7-3x+y-z}AlₓLa_{3-y}Ca_{y}Zr_{2-z}Ta_{z}O_{12 (VII),}

wherein:
0<x<0.15;
0<y<0.3; and
0.2<z<0.6.

Another aspect of the present invention provides a solid-state electrolyte material comprising a composition of Formula (VIII):

Li_{7-3x+y-z}BₓLa_{3-y}Ca_{y}Zr_{2-z}Ta_{z}O₁₂ (VIII),

wherein:
B is Al;
0≤x<0.25;
0<y≤0.5; and
0<z≤1.

In some embodiments, 0≤x<0.15. In other embodiments, x is 0. And, in some embodiments, x is 0<x<0.25.

In some embodiments, 0<y<0.3. In other embodiments, 0.2<z<0.6.

In some embodiments, the solid state electrolyte material comprising a composition of Formula (I), (II), (III), (IV), (V), (VI), (VII), or (VIII) has a Li⁺ conductivity of at least about 4×10⁻⁴ S/cm.

Another aspect of the present invention provides an electrode for a solid-state battery comprising a solid-state electrolyte material comprising a composition of Formula (I), (II), (III), (IV), (V), (VI), (VII), or (VIII).

Another aspect of the present invention provides a bilayer solid-state electrolyte structure comprising a porous layer and a dense layer. At least one of the porous layer and the dense layer comprises a solid-state electrolyte material comprising a composition of Formula (I), (II), (III), (IV), (V), (VI), (VII), and/or (VIII).

Another aspect of the present invention provides a trilayer solid-state electrolyte structure, comprising a first porous layer, a dense layer, and a second porous layer. At least one of the first porous layer, the dense layer, and the second porous layer comprises a solid-state electrolyte material comprising a composition of Formula (I), (II), (III), (IV), (V), (VI), (VII), and/or (VIII).

Another aspect of the present invention provides a solid-state battery comprising a solid-state electrolyte material as described herein, an electrode as described herein, a bilayer solid-state electrolyte structure as described herein, or a trilayer solid-state electrolyte structure described as herein.

In some embodiments, the solid-state electrolyte material is sintered. In some embodiments, the sintered electrolyte material is incorporated into a ceramic separator. In some embodiments, the sintered electrolyte material is incorporated into a host structure for lithium metal plating and stripping. In some embodiments, the sintered electrolyte material is in physical contact with a cathode material and anode material, forming a combined electrode pair and separator layer.

In another aspect, the present invention provides a method of forming a green body comprising a solid-state electrolyte material described herein.

In another aspect, the present invention provides a method of forming a sintered solid-state electrolyte material as described herein.

### BRIEF DESCRIPTION OF THE DRAWINGS

The figures below are provided by way of example and are not intended to limit the scope of the claimed invention.

FIGS. 1A and 1B are scanning electron microscope-backscattered electron detector (SEM-BSD) images of the cross-section and surface of a sintered Lithium lanthanum zirconium oxide (LLZO) material.

FIG. 1C is an elemental mapping of Al for the same region shown in FIG. 1B. Darker regions represent higher Al concentrations.

FIGS. 2A and 2B are SEM-BSD images of cross-sections of LLZO bilayers without Al doping (FIG. 2A), and with Al doping (FIG. 2B) according to one embodiment of a solid-state electrolyte material.

FIG. 3 is an SEM-BSD image of the cross-section of a sintered, multi-doped LLZO material according to one embodiment of a solid-state electrolyte material.

FIGS. 4A and 4B are SEM-BSD images of cross-sections of double-doped and triple-doped LLZO bilayers, respectively, according to various embodiments of a solid-state electrolyte material.

FIG. 5 shows the reference x-ray diffraction spectra of the LLZO cubic and tetragonal phases, as well as the XRD spectra of undoped LLZO and multi-doped LLZO material according one embodiment of a solid-state electrolyte material. The undoped LLZO corresponds to tetragonal phase garnet and the multi-doped LLZO corresponds to cubic phase garnet.

FIG. 6 shows voltage profiles of a battery cell comprising one embodiment of a solid-state electrolyte material. The cell was charged and discharged at room temperature at C/20 (1^{st} cycle), C/10 (cycles 2-3), and C/5 (cycles 4-7).

### DETAILED DESCRIPTION

The present invention provides a solid-state electrolyte material, a battery cell comprising such a solid-state electrolyte material, and methods of forming such a solid-state electrolyte material.

As used herein, the following definitions shall apply unless otherwise indicated.

### I. Definitions

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

As used herein, when an element is referred to as being “on,” “engaged to,” “connected to,” “attached to,” or “coupled to” another element, it may be directly on, engaged, connected, attached, or coupled to the other element, or intervening elements may be present. In contrast, when an element is referred to as being “directly on,” “directly engaged to,” “directly connected to,” “directly attached to,” or “directly coupled to” another element, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

As used herein, the term “doping” and other forms of the word refer to the presence or placement of atoms other than the base atoms in the crystal structure of the garnet material. For example, for the base structure of Li₇La₃Zr₂O₁₂ (LLZO), an atom can be substituted for a portion or all of the lithium, a portion or all of the lanthanum, a portion or all of the zirconium and/or a portion or all of the oxygen. Such substitution can be made after forming the base structure or during the formation of the base structure. Similar substitutions can be made for other garnet-based structures.

As used herein, the term “garnet” refers to the cubic or tetragonal crystal structure of LLZO.

As used herein, the term “solid-state electrolyte material” refers to a material that is suitable for use in a solid-state battery cell. The solid-state electrolyte material comprises a composition of Formula (I), (II), (III), (IV), (V), (VI), (VII), or (VIII).

As used herein, the term “green body” refers to an unsintered body (e.g., a tape and/or film) that comprises a solid-state electrolyte material.

As used herein, the term “powder bed” refers to a powder that contains lithium that is near the component or green body being sintered or otherwise thermally processed. The powder can be composed of undoped LLZO, doped LLZO, or another material containing lithium. It can act as a reservoir to supply additional lithium during thermal processing, suppressing the loss of lithium from the component or green body during the sintering or other thermal process.

As used herein, the term “porosity” refers to a volume ratio of space not occupied by the subject material (e.g., a solid-state electrolyte material) to the overall volume of the subject material, except where the context indicates otherwise. In some embodiments, unoccupied space at an edge of the subject material (e.g., a depression in an exterior surface of the subject material) is not included in the porosity determination.

As used herein, the term “stabilization of the cubic phase”, except where context indicates otherwise, refers to the stabilization of the cubic crystal form of a solid-state electrolyte material to prevent conversion of the cubic phase to a tetragonal phase (e.g., during processing). The stabilization can be complete (i.e., no conversion) or partial by reducing the amount of conversion that takes place as compared to the same material and conditions absent the same amount of stabilizing material.

As used herein, the term “secondary phases”, except where context indicates otherwise, refers to non-desired compositions that form in the structure. The secondary phases can be non-garnet or garnet. For secondary phase garnets, the composition might be different from that desired or it might have dopants located at incorrect sites. Frequently, secondary phases can impair structural or performance characteristics of the solid-state electrolyte material. For example, secondary phases may give rise to increased impedance or weakened structural properties of the solid-state electrolyte material. Exemplary secondary phases include, but are not limited to, Li₂O, Li₂CO₃, Al₂O₃, LiAlO₂, La₂Zr₂O₇, LaTaO₄, CaO, CaCO₃, ZrO₂, Li₂ZrO₃, Li₃BO₃, Li—Ca—B—O, etc. More than one secondary phase may be present.

### II. Solid-State Electrolyte Material

In one aspect, the present invention provides a solid-state electrolyte.

An ideal solid electrolyte for battery applications should have high ionic conductivity (over 10⁻⁴ S/cm), low processing energy and cost, minimal waste in manufacturing, and high chemical and electrochemical stability. The physical and electrochemical properties of the solid electrolyte are determined largely by the composition, crystalline phase, and microstructure of sintered body. These properties include electronic and ionic conductivity, electrochemical stability (to lithium metal and other positive and negative electrode materials), sintering temperature, lithium vapor pressure, and mechanical properties. Processing conditions such as sintering time, temperature, ramp rates, and additives such as sintering aids also influence the physical and electrochemical properties of the solid electrolyte.

Elemental doping of LLZO can be used to tune these properties. Generally, the use of a single dopant will modify the properties of the LLZO such that some are improved in a desirable way, and some are made worse and/or unaffected. The use of multiple dopants enables additional control of the final properties if they are combined in such a way that they do not negatively interfere with each other. When using two dopants, the added degree of freedom provides the ability to make improvements to some material properties in a desirable way, while offsetting undesirable changes. With three or more, an optimized composition can be made that is nearly ideal in all categories, provided the final material remains stable with all the dopants added. The best reported properties for LLZO to date have been achieved by doping with one or two elements.

In general, each site within the crystal has a limit to substitutions before the appearance of secondary phases for each dopant relevant to the site. In some cases, utilizing dopants in more than one crystal site can broaden the solubility window and allow an additional quantity of dopants compared to single site doping without the formation of secondary phases and/or impurities. Secondary phases and/or impurities can reduce the ionic conductivity, interact or react with Li metal, and/or cause a short circuit during manufacture or operation. In turn, doping with three elements at three sites can allow for an additional total quantity of dopants compared to two, and so on for additional dopants.

For LLZO garnet electrolytes, two crystalline phases exist: cubic and tetragonal. The cubic phase has more than two orders of magnitude higher ionic conductivity than the tetragonal phase, and is the desired phase for battery applications. The cubic phase has higher entropy than the tetragonal phase and is favored at higher temperatures. The tetragonal phase of undoped LLZO is favored at room temperature, however. Doping with Ta or Al has been shown to stabilize the cubic phase a room temperature. Other elements such as Ga and Nb have been used to successfully stabilize the cubic phase of LLZO as well. In general, these dopants generate lithium vacancies and increase the entropy of mixing, contributing to the stabilization of the cubic phase. When using dopants to stabilize the cubic phase of LLZO, room temperature ionic conductivity in excess of 10⁻⁴ S/cm has been demonstrated.

Sintering LLZO typically requires high temperature (>1200° C.) to sinter the ceramic, i.e., to create a low porosity microstructure with uniform composition. In the case of LLZO, the lithium in the composition has a significant vapor pressure at these temperatures. Vaporization of Li can create compositional gradients, prevent proper sintering and calcination, and cause decomposition of the garnet crystal structure. A powder bed comprising excess lithium, usually in the form of additional LLZO powder, is typically used in the sintering environment to limit lithium loss of the component being sintered. After sintering, the powder bed is deficient in lithium and is generally disposed as waste. Additionally, porous garnet layers can, in some embodiments and under some conditions, collapse at these high temperatures, which can be due to liquid phase sintering, or softening/creeping of the LLZO at sintering temperatures. Lowering the sintering temperature while still achieving the desired porosity (low or high) and phase-pure microstructure would reduce both the energy cost and material cost by reducing or eliminating the need for a powder bed.

Some dopants have little effect on the sintering temperature compared to undoped LLZO. However, Al-doped LLZO has been shown to exhibit lower temperature sintering (i.e., below 1200° C.) with improved densification (i.e., lower porosity after sintering). Without wishing to be bound by theory, it is believed that these properties of Al-doped LLZO may be due to the formation of transient liquid phases containing Li and Al that change the sintering kinetics due to liquid-phase sintering. Alternatively, these properties of Al-doped LLZO may also be due to how Al impacts the volatility of lithium in LLZO. The amount of Al required to stabilize the cubic phase is greater than about 0.15 moles of Al per formula unit (pfu), i.e., Li_{6.55}Al_{0.15}La₃Zr₂O₁₂. However, the amount of Al needed to act as a sintering aid can be much lower. When LLZO has been doped with Al at greater than about 0.15 pfu, Al-rich regions have been observed in the grain boundaries and correlated with instability towards lithium metal during cell cycling.

In many cases, Al is introduced to the LLZO material during calcination or sintering by the use of Al₂O₃-rich crucibles, which are reactive towards LLZO. When using a pure Al₂O₃ crucible during calcination, for example, up to about 0.24 Al pfu or more can be added to the LLZO. The amount of Al cannot be strictly controlled by this type of process. Instead, in some embodiments, addition of controlled amounts of Al may be accomplished by using the desired amount of Al-containing precursor material before calcination, and calcining and/or sintering on a substrate that comprises less than about 5% Al₂O₃.

In some embodiments, the Al content is limited significantly below about 0.1 pfu to prevent segregation to the grain boundaries. Without wishing to be bound by theory, it is believed that the presence of Al at less than about 0.15 pfu, less than about 0.12, or less than about 0.10 pfu, and in some embodiments from about 0.01 pfu to about 0.08 pfu, significantly improves the densification and lowers the porosity of the sintered LLZO without the formation of unstable secondary phases.

Additionally, and also without wishing to be bound by theory, it is believed that limiting Al doping to less than about 0.15 pfu (e.g., less than about 0.12 pfu, less than about 0.10 pfu, and in some embodiments from about 0.01 pfu to about 0.08 pfu), benefits the LLZO by acting as a sintering aid, beneficially lowering the sintering temperature while minimizing porosity without creating Al-rich grain boundaries. However, alone, this low amount of Al is not enough to stabilize the cubic phase of LLZO. Additional dopants can be used in conjunction with Al to stabilize the cubic phase. For example, Ta can be co-doped with Al to stabilize the cubic phase, where the Al is doped at Li sites, and Ta is doped at the Zr site. In general, Ta doping at greater than about 0.2 pfu (e.g., greater than about 0.35 pfu, or greater than about 0.4 pfu and less than about 0.6 pfu), may be used to stabilize the cubic phase. Because Al³⁺ and Ta⁵⁺ are both higher oxidation state than the elements they are replacing (Li¹⁺ and Zr⁴⁺, respectively), this degree of doping creates a large amount of Li vacancies, and a corresponding reduction in the amount of lithium in the crystal structure. This reduction in lithium can be detrimental to the physical properties (e.g., the Li⁺ conductivity), because there is much less lithium present for conduction. Adding a third dopant at the La³⁺ site with a lower valence than La³⁺, for example Ca²⁺ or Sr²⁺, can offset the vacancies created by other dopants, and more lithium can be added to the composition. For example, for a system doped with about 0.1 pfu of Al and about 0.4 pfu of Ta, about 0.7 lithium vacancies pfu would be created, leaving about 6.3 Li pfu. If the about 0.2 pfu of Sr is doped to the La site, then about 6.5 Li pfu would be the correct stoichiometry (i.e., Li_{6.5}Al_{0.1}La_{2.8}Sr_{0.2}Zr_{1.6}Ta_{0.4}O₁₂).

In some embodiments, when the type and amount of dopants have been properly selected, an increase to the conductivity beyond what can be found with only two dopants can be achieved. In this example, the first dopant is used to stabilize the cubic phase, another is used as a sintering aid, and third is used to balance the lithium content to a desirable level. Doping with three elements as described herein can lower the sintering temperature, improve densification/lower porosity with little or no detectable secondary phases, and optimize the Li⁺ ion conductivity without sacrificing the other beneficial properties of LLZO. Additional unexpected “cocktail” effects are also possible when doping with multiple elements, such unexpected changes to the mechanical properties, flexural strength, modulus of elasticity, or hardness, or unexpected changes to physical properties, such as reduced lithium volatility at high temperatures (e.g., during calcination and sintering), lower sintering temperature requirements, formation of low temperature eutectic phases, or unexpected changes to the electrochemical properties such as large changes to the ionic or electronic conductivity, stability to water, air, CO₂, or other materials, among other unexpected benefits.

Different dopants, or additional dopants beyond three can be used to further tune the properties as desired. As an example, the ability to control properties such as the porosity greater may, in some cases, be desirable. The composition of the LLZO can be suitably changed to modify the sintering temperature and densification rates, enabling control over the porosity. Furthermore, a dense-porous bilayer type microstructure (i.e., a low porosity layer next to a high porosity layer) can be achieved when the optimum composition for each layer has been suitably chosen.

The present approach provides a multi-element doping strategy with LLZO comprising 3 or more dopants to optimize the combination of physicochemical properties described above for application as a lithium conducting solid electrolyte. After sintering, certain embodiments of the composition can have high Li⁺ conductivity, in excess of 4×10⁻⁴ S/cm, very low and controllable porosity, and little or no detectable secondary phases. In addition, certain embodiments following the multi-element doping strategy can have unexpected properties, such as lower volatility of lithium at elevated temperatures. This can provide the ability to be calcined with less (or no) excess lithium above the stoichiometric amount to compensate for lithium loss. This property can also provide the ability to be sintered without the use of a powder bed or other lithium source external to the green body to compensate for lithium loss during sintering.

When using the three or more dopants, the entropy of mixing tends to be higher than when using two or fewer dopants, based on the following equation:

$$Δ {S}_{m i x} = - R {\sum }_{i = 1}^{N} {n}_{i} ln {n}_{i}$$

wherein
Sₘᵢₓ is the entropy of mixing,
R is the universal gas constant,
N is number of elements in the mixture, and
nᵢ is the atomic fraction of each element i.

Because the cubic phase of garnet is a higher entropy phase than the tetragonal phase, using three or more dopants can increase the stability of the cubic phase. In addition, using dopants that create lithium or oxygen vacancies in the crystal structure can also increase the entropy. This can result in lower calcination or sintering temperatures for cubic phase LLZO. Disorder favors the more symmetric cubic phase. Utilizing three or more dopants increases disorder relative to two, one, or no dopants while still maintaining the single cubic garnet phase, for example, no or reduced formation or presence of secondary or impurity phases.

In certain embodiments, an anion can be doped into the crystal structure by replacing some of the O²⁻ atoms with one or more anions. Examples of anions include F⁻, Cl⁻ and any combination thereof. Anion doping can have similar effects as cation doping. Anion doping can have the added benefit of making the garnet surface more stable to reaction in both the calcined powder product and the sintered product. The product can be more stable to air, i.e., ambient H₂O and CO₂, and have a more stable interface with electrode materials.

The present approach includes methods for manufacturing multi-doped LLZO garnet compositions. In some embodiments, the composition may be made by blending precursors together and calcining at a set temperature and for a set amount of time to produce the doped garnet material. The precursors can be salts, carbonates, oxides, nitrates, and/or hydroxides of the elements desired for the doped garnet material. After calcining, the doped garnet material can be optionally milled to reduce the particle size. The doped garnet material can be fabricated into a desired structure, such as by sintering or by forming a composite with other materials such as polymers, ceramic, glasses, conductive carbons, or other materials, including, but not limited to other ionically conductive materials. Calcining and sintering may be accomplished in the same or separate processing steps.

The present approach has considerable advantages over contemporary LLZO technologies such as S. Ohta, et al., Co-sinterable lithium garnet-type oxide electrolyte with cathode for all-solid-state lithium ion battery, J. Power Sources, 2014, 265, 40-44, and U.S. Application Publication 2015/0056519, filed Aug. 20, 2014, and incorporated by reference in their entirety. First, Ohta's powder product pre-sintering is doped with two elements (Ca and Nb) instead of three or more. In preparation for sintering, Ohta teaches that the powder is mixed with Al₂O₃ and Li₃BO₃ as processing additives, not as substitutes or dopants. This is a significant drawback compared to the present approach. When doping with an element such as Al, a corresponding amount of Li should be reduced from the composition to allow room for the Al to enter the crystal lattice without excess material leftover beyond the stoichiometric composition which could form a secondary phase. Generally, doping happens during the synthesis or calcination step to produce the LLZO product. Ohta, on the other hand, teaches that the elements are added as “additives” after the calcination step. Furthermore, the Al₂O₃ and Li₃BO₃ additives are shown to remain as secondary phases after sintering, rather than forming a single-phase, low-porosity product. This can be seen in Ohta's SEM-EDX images, which clearly show regions of high B and Ca content separate from LiLaZrNbAl regions. Ohta's final composition in the sintered product is a two-element doped LLZO (doped with Al and Nb) with a Li—Ca—B—O grain boundary product that is generated during sintering. The present approach has no such grain boundary product and does not include the use of additives containing the element B or that contain inorganic elements not already present in the doped LLZO composition.

The present approach has considerable advantages over contemporary LLZO technologies such as JP 2021093308. This reference discloses a method to for a crystal grain aggregate composed of an LLZO material that has been calcined but not sintered. The present approach, however, details a multi-doped LLZO powder and multi-doped LLZO sintered structure. In addition, while this reference discloses a formula which may contain 3 dopants, no doping strategy which would guide the selection of the type, amount of each dopant, and how to balance the dopants with the Li, La, Zr, and O elements in the composition is disclosed, nor any discussion about the relationship between the dopants and their effects on the properties. Additionally, all embodiments have two or fewer dopants used. Thus this reference does not teach how to dope LLZO with three or more elements in a meaningful way. The present approach teaches how to produce a multi-doped LLZO powder product and sintered product, with detailed emphasis on how to combine dopants and balance the composition to achieve the desired results.

Some embodiments of the present invention provide a solid-state electrolyte material comprising a composition of Formula (I):

M1₇₋ₓD1ₐM2_{3-y}D2₆M3_{2-z}D3_{c}O_{12-w}D4_{d} (I),

wherein:
M1 is Li;
M2 is La;
M3 is Zr;
D1 is H, Be, B, Al, Fe, Zn, Ga, Ge, or any combination thereof;
D2 is Na, K, Ca, Rb, Sr, Y, Ag, Ba, Bi, Pr, Nd, Pm, Sm, Gd, Tb, Dy, Ho, Er, Tm, Zn, Ce, or any combination thereof;
D3 is Mg, Si, Sc, Ti, V, Cr, Mn, Co, Ni, Cu, Ge, As, Se, Nb, Mo, Tc, Ru, Rh, Pd, Cd, In, Sn, Sb, Hf, Ta, W, Ir, Pt, Au, Hg, Tl, Pb, Ce, Eu, Te, Y, Sr, Ca, Ba, Gd, Ge, or any combination thereof;
D4 is F, Cl, Br, I, S, Se, Te, N, P, or any combination thereof;
0≤w≤2;
0.5<x≤3;
0≤y≤3;
0≤7≤2;
0≤a≤2;
0≤b≤3;
0≤c≤2; and
0≤d≤2,
   wherein at least one of a, b, c, and d is not zero.

In some embodiments, 0<y≤3, 0<z≤2, 0<a≤2, and 0<b≤3, and 0<c≤2.

In some embodiments, 0≤w≤1. In other embodiments, 0≤w≤0.5. And, in some embodiments, 0≤w≤0.1.

In some embodiments, 0≤x≤1. In other embodiments, 0≤x≤1. And, in some embodiments, 0.2≤x≤0.8.

In some embodiments, 0<y<3. In other embodiments, 0<y<1. In some embodiments, 0<y<0.5. And, in some embodiments, 0.05≤y≤0.25.

In some embodiments, 0<a≤1. In other embodiments, 0<a<0.24.

In some embodiments, 0<b<3. In other embodiments, 0<b<1. In some embodiments, 0<b<0.5. And, in some embodiments, 0.05≤b≤0.25.

In some embodiments, 0<c≤0.7. In other embodiments, 0<c≤0.5. And, in some embodiments, 0.2≤c≤0.5.

In some embodiments, 0≤d≤1. In other embodiments, 0≤d≤0.5. And, in some embodiments, 0≤d≤0.1.

In some embodiments, D1 is Al, Fe, Zn, and Ga, or any combination thereof. For example, D1 may be Al. In other embodiments, D1 is Fe. In some embodiments, D1 is Zn. And, in some embodiments, D1 is Ga.

In some embodiments, D2 is Ca, Sr, Ba, Bi, and Nd, or any combination thereof. For example, D2 may be Ca. In some embodiments, D2 is Sr. In other embodiments, D2 is Ba. In some embodiments, D2 is Bi. And, in some embodiments, D2 is Ba.

In some embodiments, D3 is Ta, Nb, W, Ti, and Mo, or any combination thereof. For example, D3 may be Ta. In some embodiments, D3 is Nb. In other embodiments, D3 is W. In some embodiments, D3 is Ti. And, in some embodiments, D3 is Mo.

In some embodiments, 7−x=7−a(vD1)+b(3−vD2)+c(4−vD4)−d/2, wherein vD1 is an oxidation state of D1, vD2 is an oxidation state of D2, and vD3 is an oxidation state of D3; D4 is F, Cl, Br, I, or any combination thereof; y=b; z=c; and w=d. In some embodiments, 0≤x≤1.0.

Other embodiments of the present invention provide a solid-state electrolyte material comprising a composition of Formula (II):

Li₇₋ₓD1ₐLa_{3-y}D2_{b}Zr_{2-z}D3_{c}O_{12-w}D4_{d} (II),

wherein:
D1 is H, Be, B, Al, Fe, Zn, Ga, Ge, or any combination thereof;
D2 is Na, K, Ca, Rb, Sr, Y, Ag, Ba, Bi, Pr, Nd, Pm, Sm, Gd, Tb, Dy, Ho, Er, Tm, Zn, Ce, or any combination thereof;
D3 is Mg, Si, Sc, Ti, V, Cr, Mn, Co, Ni, Cu, Ge, As, Se, Nb, Mo, Tc, Ru, Rh, Pd, Cd, In, Sn, Sb, Te, I, Hf, Ta, W, Ir, Pt, Au, Hg, Tl, Pb, Ce, Eu, Te, Y, Sr, Ca, Ba, Gd, Ge, or any combination thereof;
D4 is F, Cl, Br, I, S, Se, Te, or any combination thereof;
0≤w<2;
−0.5<x≤3;
0<y≤3;
0<z≤2;
0<a≤2;
0<b≤3; 0<c≤2; and
0≤d≤2.

In some embodiments, 0≤w≤1. In other embodiments, 0≤w≤0.5. And, in some embodiments, 0≤w≤0.1.

In some embodiments, 0<x≤1.5. In some embodiments, 0.0<y≤2. In other embodiments, 0.5<y≤2. And, in some embodiments, 0.5<z≤1.5.

In some embodiments, 0<a<0.24. In some embodiments, 0<b≤2. And, in some embodiments, 0<c≤1.5.

In some embodiments, 0≤d≤1. In other embodiments, 0≤d≤0.5. And, in some embodiments, 0≤d≤0.1.

In some embodiments, D1 is Al or Ga. For example, D1 may be Al. In other embodiments, D1 is Ga.

In some embodiments, D2 is Ca, Sr, Ba, or any combination thereof. For example, D2 may be Ca. In other embodiments, D2 is Sr. And, in some embodiments, D2 is Ba.

In some embodiments, D3 is Ta, Nb, W, Ti, Mo, or any combination thereof. For example, D3 may be Ta. In some embodiments, D3 is Nb. In other embodiments, D3 is W. In some embodiments, D3 is Ti. And, in some embodiments, D3 is Mo.

In some embodiments, D4 is F, Cl, or any combination thereof. For example, D4 may be F. In other embodiments, D4 may be Cl.

In some embodiments, 0<a≤0.25. In some embodiments, 0<b≤0.5. In some embodiments, 0<c≤1.0. And, in some embodiments, 0≤d≤0.25.

In some embodiments, 0≤x≤1.0. In some embodiments, 0≤y≤0.5. In some embodiments, 0≤z≤1.0. And, in some embodiments, 0≤w≤0.25.

In some embodiments, 7−x=7−a(vD1)+b(3−vD2)+c(4−vD4)−d/2, wherein vD1 is an oxidation state of D1, vD2 is an oxidation state of D2, and vD3 is an oxidation state of D3; D4 is F, Cl, Br, I, or any combination thereof; y=b; z=c; and w=d. In some embodiments, 0≤x≤1.0.

In some embodiments of compositions of Formula (II):
D1 is Al, Ga, or any combination thereof, and 0<a≤0.15;
D2 is Ca, Sr, Ba, or any combination thereof, and 0<b≤0.5;
D3 is Ta, Nb, W, Ti, Mo, or any combination thereof, and 0<c≤1.0;
D4 is F, Cl, or any combination thereof, and 0≤d≤0.25;
0≤x≤1.0;
0≤y≤0.5;
0≤z≤1.0; and
0≤w≤0.25.

Isovalent substitution is where the dopant has the same charge as the element for which it is being substituted; aliovalent substitution is where the dopant has a different charge than the element for which it is being substituted. In some embodiments, the doping can be aliovalent or isovalent. In some embodiments, there can be a combination of aliovalent and isovalent substitution in a garnet composition. For example, Y³⁺ can substitute for La³⁺, or H⁺ for Li⁺ in isovalent substitution. In contrast, Ca²⁺ can substitute for La³⁺ which would be aliovalent substitution. Aliovalent substitution can introduce cation or anion vacancies in the crystal structure. Aliovalent and isovalent doping can be used to strategically control the number vacancies in the crystal structure and the stoichiometric amount of the other elements in the LLZO composition.

In some embodiments, the solid-state electrolyte material comprises a composition set forth in Table 1.

TABLE 1
Exemplary compositions for a solid-state electrolyte material.

| Example | Li | D1 | La | D2 | Zr | D3 | O | D4 |
|---|---|---|---|---|---|---|---|---|
| 1 | 6.40 | Al - 0.05 | 2.95 | Ca - 0.05 | 1.50 | Ta - 0.50 | 12 | 0 |
| 2 | 6.75 | 0 | 2.75 | Ca - 0.25 | 1.50 | Ta - 0.50 | 12 | 0 |
| 3 | 6.30 | Ga - 0.15 | 2.95 | Ba - 0.05 | 1.70 | Nb - 0.30 | 12 | 0 |
| 4 | 6.85 | Al - 0.15 | 2.70 | Sr - 0.30 | 1.00 | Ti - 1.00 | 12 | 0 |
| 5 | 6.30 | Ga - 0.08 | 2.76 | Mg - 0.24 | 1.65 | W - 0.35 | 12 | 0 |
| 6 | 6.6 | Al - 0.05 | 2.90 | Ca - 0.10 | 1.70 | Ta - 0.30 | 11.90 | F - 0.10 |

In some embodiments, a solid-state electrolyte material comprises a composition of Formula (III):

Li_{7-3x-y+z}BₓLa_{3-y}C_{y}Zr_{2-z}D_{z}O₁₂₋ₐG_{2a/n} (III),

wherein:
B is any trivalent cation (e.g. Al³⁺ or Ga³⁺) or any combination thereof (in some embodiments, the charge can be compensated by removing 3 Li for 1 trivalent B);
C is any divalent cation (e.g., Mg²⁺) or any combination thereof; and
D is any pentavalent cation (e.g., Nb⁵⁺) or any combination thereof;
G is any monovalent anion (e.g., F⁻), divalent anion (e.g. S²⁻), or trivalent anion (e.g. N³⁻), or G is absent;
n is the charge of the dopant;
0<x≤0.5;
0<y≤3;
0<z≤2; and
0≤a≤12.

In some embodiments, 0<x<0.24. In other embodiments, 0.1<y≤1.5. In some embodiments, 0.2<z≤1. And, in some embodiments, 0≤a≤0.5.

In some embodiments, B is Al, Ga, H, Fe, Zn, or any combination thereof. For example B may be Al. In other embodiments, B is Ga. In some embodiments, B is H. In some embodiments, B is Fe. And, in some embodiments, B is Zn.

In some embodiments, C is Ca, Mg, Sr, Ba, Na, Ce, or any combination thereof. For example, C may be Ca. In other embodiments, C is Mg. In some embodiments, C is Sr. In some embodiments, C is Ba. In other embodiments, C is Na. And, in some embodiments, C is Ce.

In some embodiments, D is Ta, Y, Mo, Sb, Nb, W, Ge, Ti, or any combination thereof. For example, D is Ta. In other embodiments, D is Y. In some embodiments, D is Mo. In some embodiments, D is Sb. In some embodiments, D is Nb. In other embodiments, D is W. In some embodiments, D is Ge. And, in some embodiments, D is Ti.

In some embodiments, G is F, Cl, or any combination thereof, or G is absent. For example, G may be F. In other embodiments, G is Cl. And, in some embodiments, G is absent.

In some embodiments of compositions of Formula (III):
B is Al, Ga, H, Fe, Zn, or any combination thereof, and 0<x<0.24;
C is Ca, Mg, Sr, Ba, Na, Ce, or any combination thereof, and 0.1<y≤1.5;
D is Ta, Y, Mo, Sb, Nb, W, Ge, Ti, or any combination thereof, and 0.2<z≤1; and
G is F, Cl, or any combination thereof, and 0≤a≤0.5, or G is absent.

In some embodiments, a solid-state electrolyte material comprises a composition of Formula (IV):

LiₙBₓ^{vB}La_{3-y}C_{y}^{vC}Zr_{2-z}D_{z}^{vD}O₁₂₋ₐGₐ (IV),

wherein:
n=7−x(vB)+y(3−vC)+z(4−vD)−a/2;
vB is an oxidation state of dopant B, vC is an oxidation state of dopant C, and vD is an oxidation state of dopant D (note that in this formula, any change is vacancies and charge is balanced by the amount of lithium in the formula, but a similar approach can be used by also balancing the amount of oxygen in the formula);
B is H⁺, Al³⁺, Ga³⁺, Fe³⁺, Zn²⁺, Ge⁴⁺, or any combination thereof;
C is Ca²⁺, Ba²⁺, Sr²⁺, Mg²⁺, Rb⁺, Ce⁴⁺, or any combination thereof;
D is Ta⁵⁺, Y³⁺, Mo⁶⁺, Nb⁵⁺, W⁶⁺, Ge⁴⁺, Ti⁴⁺, or any combination thereof;
G is F, Cl, Br, I, or any combination thereof;
0<x<0.24;
0<y≤1.0;
0<z≤1.0; and
0≤a≤1.0.

For each of the cations listed for B, C, and D, different oxidation states of the cation may be used where applicable, to change the balance of lithium or oxygen in the system and control the final properties of the solid electrolyte as desired. Furthermore, where combinations of cations are doped at any particular site with the same or different oxidation state, Formula (IV) can be used adding identical terms to the equation for n. For example, if dopants for the Li site B1 and B2 were desired, then the equation for n becomes n=7−x1(vB1)−x2(vB2)+y(3−vC)+z(4−vD)−a/2. Similar modifications can be made for multiple C dopants, D dopants, or G dopants, or combinations thereof.

In some embodiments, B is Al³⁺. In some embodiments, C is Ca²⁺. In some embodiments, D is Ta⁵⁺, Nb⁵⁺, Ti⁴⁺, or any combination thereof. For example, D may be Nb⁵⁺. In some embodiments, D is Ti⁴⁺. And, in some embodiments, D is Ta⁵⁺.

In some embodiments, 0<x<0.15. In other embodiments, 0.02<x<0.10.

In some embodiments, 0<y<0.50. In other embodiments, 0.1<y<0.30. And, in some embodiments, 0.15<y<0.28.

In some embodiments, 0<z<0.70. In other embodiments, 0.3<z<0.6. And, in some embodiments, 0.4<z<0.55.

In some embodiments, 0≤a<0.1. In other embodiments, 0≤a<0.05. And, in some embodiments, x, y, z, and a are selected such that 6≤n≤7.

It should be appreciated that Formula (III) and Formula (IV) may be used as guidance when selecting compositions for Formula (I) and Formula (II), particularly with respect to the composition of a particular element relative to other elements. The relative compositions are useful in producing a single phase garnet solid-state electrolyte material.

In some embodiments, a solid-state electrolyte material comprises a composition of Formula (V):

Li₇₋ₓBₐLa_{3-y}C_{b}Zr_{2-z}D_{c}O₁₂ (V),

wherein:
B is Al or Ga;
C is Ca, Sr, Ba, or Mg;
D is Ta, Nb, W, Mo, or Ti;
−0.5<x≤1;
0<a<0.24;
0<y≤0.5;
0<b≤0.5;
0<z≤1; and
0<c≤1.

In some embodiments, B is Al. In other embodiments, B is Ga.

In some embodiments, C is Ca. In other embodiments, C is Sr. In some embodiments, C is B. And, in some embodiments, C is Mg.

In some embodiments, D is Ta. In other embodiments, D is Nb. In some embodiments, D is W. In some embodiments, D is Mo. And, in some embodiments, D is Ti.

In some embodiments, 0.2≤x≤0.8. In other embodiments,

For example, in some embodiments of compositions according to Formula (V):
0.2≤x≤0.8;
0<a≤0.15;
0<y≤0.3;
0<b≤0.3;
0<z≤1; and
0<c≤1.

In some embodiments, the solid-state electrolyte material comprises a composition set forth in Table 2.

TABLE 2
Exemplary compositions for a solid-state electrolyte material.

| Example | Li | B | La | C | Zr | D | O |
|---|---|---|---|---|---|---|---|
| 1 | 6.40 | Al - 0.05 | 2.95 | Ca - 0.05 | 1.50 | Ta - 0.50 | 12 |
| 2 | 6.75 | — | 2.75 | Ca - 0.25 | 1.50 | Ta - 0.50 | 12 |
| 3 | 6.30 | Ga - 0.15 | 2.95 | Ba - 0.05 | 1.70 | Nb - 0.30 | 12 |
| 4 | 6.85 | Al - 0.15 | 2.70 | Sr - 0.30 | 1.00 | Ti - 1.00 | 12 |
| 5 | 6.30 | Ga - 0.08 | 2.76 | Mg - 0.24 | 1.65 | W - 0.35 | 12 |

In other embodiments, a solid-state electrolyte material comprises a composition of Formula (VI):

Li_{7+y-z}La_{3-y}Ca_{y}Zr_{2-z}Ta_{z}O₁₂ (VI),

wherein:
0<y<0.3; and
0.2<<<0.6.

For example, in some embodiments of compositions according to Formula (VI):
0.1<y<0.3; and
0.2<z<0.6.

In some embodiments, a solid-state electrolyte material comprises a composition of Formula (VII):

Li_{7-3x+y-z}AlₓLa_{3-y}Ca_{y}Zr_{2-z}Ta_{z}O₁₂ (VII),

wherein:
0<x<0.15;
0<y<0.3; and
0.2<z<0.6.

For example, in some embodiments of compositions according to Formula (VII):
0.1<y<0.3; and
0.2<z<0.6.

In some embodiments, a solid-state electrolyte material comprises a composition of Formula (VIII):

Li_{7-3x+y-z}BₓLa_{3-y}Ca_{y}Zr_{2-z}Ta_{z}O₁₂ (VIII),

wherein:
B is Al;
0≤x<0.25;
0<y≤0.5; and
0<z≤1.

In some embodiments, 0≤x<0.15. In other embodiments, x is 0. In some embodiments, x is 0<x<0.25. And, in some embodiments, 0<x<0.15.

In some embodiments, 0<y<0.5. In other embodiments, 0<y<0.3.

In some embodiments, 0<z<1. In other embodiments, 0.2<z<0.6.

Unless otherwise stated, each subscript in any chemical formula set forth herein is significant to the hundredths place, and a range of subscripts includes each hundredths value between the upper and lower boundaries of the range. For example, the range 0<x<1 includes 0.01, 0.02, through 0.98, and 0.99.

Unless otherwise stated, when any constituent (e.g., D1, D2, D3, D4, B, C, D, and/or G) of any chemical formula set forth herein is a combination of different elements (e.g., Li, Na, and K), a combination of different types of cations (Li⁺, Na⁺, or K⁺), or a combination of different types of anions (e.g., Cl⁻, Br⁻, and I⁻), the subscript immediately following such constituent (e.g., a, b, c, and/or d) represents the aggregate pfu for all elements, types of cations, or types of anions in the combination. And, when any constituent (e.g., D1, D2, D3, D4, B, C, D, and/or G) of any chemical formula set forth herein is a single element (e.g., Li, Na, or K), a single type of cation (Li⁺, Na⁺, or K⁺), or a single type of anion (e.g., Cl⁻, Br⁻, or I⁻), the subscript immediately following such constituent (e.g., a, b, c, and/or d) represents the aggregate pfu for such element, type of cation, or type of anion.

In some embodiments, the solid-state electrolyte material is sintered. In some embodiments, the sintered electrolyte material is incorporated into a ceramic separator. In some embodiments, the sintered electrolyte material is incorporated into a host structure for lithium metal plating and stripping. In some embodiments, the sintered electrolyte material is in physical contact with a cathode material and anode material, forming a combined electrode pair and separator layer.

Another aspect of the present invention provides an electrode for a solid-state battery. The electrode comprises a solid-state electrolyte material. The solid-state electrolyte material comprises a composition of Formula (I), (II), (III), (IV), (V), (VI), (VII), and/or (VIII).

Another aspect of the present invention provides a bilayer solid-state electrolyte structure. The bilayer solid-state electrolyte structure comprises a porous layer and a dense layer. At least one of the porous layer and the dense layer comprises a solid-state electrolyte material comprising a composition of Formula (I), (II), (III), (IV), (V), (VI), (VII), and/or (VIII).

Another aspect of the present invention provides a trilayer solid-state electrolyte structure. The trilayer solid-state electrolyte structure comprises a first porous layer, a dense layer, and second porous layer. At least one of the first porous layer, the dense layer, and the second porous layer comprises a solid-state electrolyte material comprising a composition of Formula (I), (II), (III), (IV), (V), (VI), (VII), and/or (VIII). In some embodiments, the dense layer is disposed between the first and second porous layers.

Another aspect of the present invention provides a solid-state battery comprising a solid-state electrolyte material as described herein, an electrode as described herein, a bilayer solid-state electrolyte structure as described herein, or a trilayer solid-state electrolyte structure described as herein.

### III. Methods of Forming a Green Body

In another aspect, the present invention provides a method of forming a green body. The method comprises:
(a) reacting a precursor mixture to form a solid-state electrolyte material described herein;
(b) dispersing the solid-state electrolyte material in a solvent to form a dispersed material;
(c) mixing a first portion of the dispersed material with a first binder and a first plasticizer to form a dense mixture;
(d) mixing a second portion of the dispersed material with a second binder, a second plasticizer, and a pore-forming agent to form a porous mixture;
(e) casting the dense mixture on a first substrate to form a dense cast tape;
(f) casting the porous mixture on a second substrate to form a porous cast tape;
(g) drying the dense cast tape and the porous cast tape; and
(h) laminating the dense cast tape with the porous cast tape for form a green body.

In some implementations, the method comprises adding a lithium-donating compound to at least one of the dispersed material, the dense mixture, and the porous mixture. For example, the method may comprise adding a lithium-donating compound to the dispersed material. In other implementations, the method may comprise adding a lithium-donating compound to the dense mixture. And, in some implementations, the method may comprise adding a lithium-donating compound to the porous mixture.

In some implementations, the reacting step (a) comprises calcining the precursor mixture. For example, the calcining may be performed in a heated crucible. In some implementations, the crucible comprises less than about 5 wt % Al₂O₃.

In some implementations, the calcining is performed at a temperature of from about 600° C. to about 1,200° C. In other implementations, the calcining is performed at a temperature of from about 700° C. to about 1,100° C. In some implementations, the calcining is performed at a temperature of from about 800° C. to about 1,000° C. And, in some implementations, the calcining is performed at a temperature of about 900° C.

In some implementations, the calcining is performed for at least about 1 minute (e.g., from about 1 minute to about 60 minutes, from about 5 minutes to about 45 minutes, from about 10 minutes to about 45 minutes, from about 15 minutes to about 30 minutes, from about 3 minutes to about 10 minutes, or from about 5 minutes to about 15 minutes). In other implementations, the calcining is performed for at least about 1 hour (e.g., from about 1 hour to about 5 hours, from about 1.5 hours to about 4.5 hours, from about 2 hours to about 4 hours, or from about 2.5 hours to about 3.5 hours). In some implementations, the calcining is performed for at least about 5 hours (e.g., from about 5 hours to about 12 hours, from about 6 hours to about 10 hours, or from about 6 hours to about 8 hours). In some implementations, the calcining is performed for a period of from about 10 hrs to about 14 hrs.

In some implementations, the reacting step (a) further comprises
(a-1) reacting a precursor mixture to form a solid-state electrolyte material; and
(a-2) milling the solid-state electrolyte material to increase uniformity and reduce particle size.

In some implementations, milling step (a-2) is performed prior to dispersing the solid-state electrolyte material (i.e., step (b)).

In some implementations, the method further comprises de-aerating at least one of the dense mixture and the porous mixture under vacuum. For example, in some implementations, the dense mixture is de-aerated under vacuum. In other implementations, the porous mixture is de-aerated under vacuum. And, in some implementations, the dense mixture and the porous mixture are de-aerated under vacuum.

In some implementations, the step of drying (g) is performed at a temperature of from about 20° C. to about 100° C. In other implementations, the step of drying (g) is performed at a temperature of from about 40° C. to about 80° C. And, in some implementations, the step of drying (g) is performed at a temperature of from about 50° C. to about 70° C.

In some implementations, laminating step (h) comprises
(h-1) stacking the porous cast tape and the dense cast tape; and
(h-2) passing the stacked tapes through a heated roller press.

In some implementations, stacking step (h-1) may comprises stacking the porous cast tape on the dense cast tape. In other implementations, stacking step (h-1) comprises stacking the dense cast tape on the porous cast tape. And, in some implementations, the method comprises repeating the laminating step (h) to form a multilayer green body.

In some implementations, the heated roller press is heated to a temperature of from about 50° C. to about 500° C. In other implementations, the heated roller press is heated to a temperature of from about 100° C. to about 300° C. And, in some implementations, the heated roller press is heated to a temperature of from about 150° C. to about 250° C.

Another aspect of the present invention provides a method of forming a sintered solid-state electrolyte. The method comprises forming a green body according to any method described herein. The method also comprises sintering the green body to form the sintered solid-state electrolyte.

In some implementations, the step of sintering is performed at a temperature of less than or equal to about 1,200° C. For example, the step of sintering may be performed at a temperature of from about 900° C. to about 1,200° C. In some implementations, the step of sintering is performed for about 1 minute to about 10 hours (e.g., from about 1 min to about 1 hour, from about 3 min to about 15 min, from about 5 min to about 30 min, from about 30 min to about 60 min, from about 1 hr to about 3 hrs, or from about 2 hrs to about 4 hrs). For example, the sintering step may be performed for about 1 minute to about 6 hours.

### IV. Examples

In order that the invention described herein may be more fully understood, the following examples are set forth. The examples described in this application are offered to illustrate the methods and solid-state electrolyte materials provided herein and are not to be construed in any way as limiting their scope.

Solid-State Electrolyte Materials

### Example 1: Solid State Electrolyte Material of Formula (VI)

A blended raw material powder was prepared in the desired stoichiometry to arrive at a multi-doped lithium lanthanum zirconium oxide (LLZO) of the formula Li_{7+y-z}La_{3-y}Ca_{y}Zr_{2-z}Ta_{z}O₁₂, wherein 0.1<y<0.3 and 0.2<z<0.6 (i.e., Formula (VI) described herein). Precursor materials for this example embodiment include lithium hydroxide monohydrate (98%, Alfa Aesar), lanthanum oxide (GFS Chemicals, 99.9%), zirconium (IV) oxide (Inframat Advanced Materials, 99.9%), calcium carbonate (Sigma Aldrich, 99.0%), and tantalum (V) oxide (MPIL, 99.9%). Ca²⁺ was used to dope the La site and Ta⁵⁺ was used to dope the Zr site.

The blended raw material powder was calcined in a crucible at 900° C. for ~12 hours (h) to form a garnet powder. In this example, the crucible was comprised of <5 wt % Al₂O₃ to prevent the transfer of aluminum. Crucibles comprised of MgO and/or Pt are suitable examples of such crucibles. The garnet powder was then milled in isopropanol to achieve a uniform and small particle size, followed by drying at 55° C. to remove the isopropanol. The resulting prepared garnet powder was then mixed with isopropanol and toluene as solvents, and Z3 menhaden fish oil as a dispersant, and milled overnight with milling media to create a dispersion. It will be appreciated that other milling and dispersion methods may be used. Polyvinyl butyral (i.e., a binder) and benzyl butyl phthalate (i.e., a plasticizer) were then added to the dispersion with mixing, and the dispersion was then de-aerated by mixing under vacuum. The de-aerated dispersion was then cast on a biaxially-oriented polyethylene terephthalate film (e.g., a Mylar® film) with a doctor blade to form a cast tape (i.e., a “dense tape”). The cast tape was dried at 55° C., forming a green body of a solid-state electrolyte material. Another tape (i.e., a “porous tape”) was also cast in a similar manner, except that a pore-forming agent was mixed in during the addition of the binder and the plasticizer. The porous tape was laminated with the dense tape by stacking the tapes and passing the tapes through a heated roller press at 200° F. (i.e., about 93.3° C.) to form a porous-dense bilayer laminate. It will be appreciated that multiple dense tapes and porous tapes can be laminated together in one step or in succession to make a multilayer laminate. The resultant bilayer laminate was placed in a tube furnace with non-alumina surfaces, to avoid aluminum transfer to the product, and with no mother powder. The bilayer laminate was then sintered at 900° C.-1200° C. for 1 minute (min)-6 h to form a sintered solid-state electrolyte material.

### Example 2: Solid State Electrolyte Material of Formula (VII)

A solid-state electrolyte material comprising a composition of the formula Li_{7-3x+y-z}AlₓLa_{3-y}Ca_{y}Zr_{2-z}Ta_{z}O₁₂, wherein 0<x<0.15, 0.1<y<0.3, and 0.2<z<0.6 (i.e., Formula (VII) described herein) was also prepared. Precursor materials for this example embodiment include lithium hydroxide monohydrate (98%, Alfa Aesar), lanthanum oxide (GFS Chemicals, 99.9%), zirconium (IV) oxide (Inframat Advanced Materials, 99.9%), aluminum oxide (AdValue Technology, 99.999%), calcium carbonate (Sigma Aldrich, 99.0%), and tantalum (V) oxide (MPIL, 99.9%). Like the composition in Example 1, Ca²⁺ was used to dope the La site and Ta⁵⁺ was used to dope the Zr site. In addition, Al³⁺ was used to dope the Li site. The composition of Formula (VII), and the resultant sintered solid state-electrolyte material, was prepared in a manner substantially similar to the composition of Formula (VI) and the sintered solid-state electrolyte material thereof, except that Al³⁺ (i.e., aluminum oxide) was introduced into the blended powder prior to calcination.

### Analysis of Solid-State Electrolytes Materials:

Any solid-sate electrolyte materials discussed in these examples, other than those already described herein in Examples 1 and 2, were prepared in a manner substantially similar to the composition of Formula (VI) as set forth in Example 1, and the sintered solid-state electrolyte material thereof, with the exception of the components used to form the underlying blended raw material powder.

The sintered solid-state electrolyte materials were tested by examination at a fracture by flexing the sintered solid-state electrolyte materials by hand using a “4-point” flexing arrangement, followed by microscopic evaluation with a scanning electron microscope-backscattered electron detector (SEM-BSD) of the fracture site and surfaces for evidence of porosity and secondary phases. It will be appreciated that a 3-point flexing arrangement may also be used.

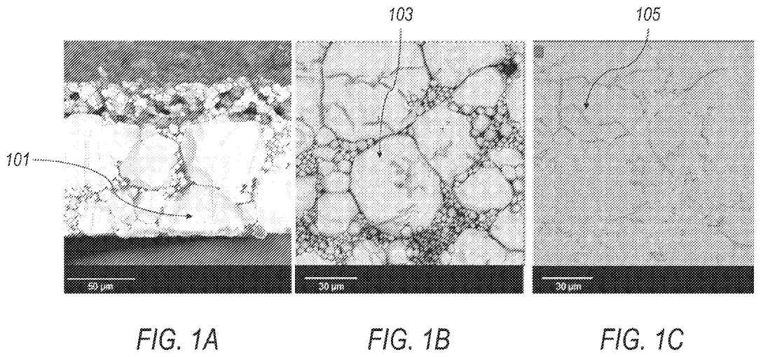

FIGS. 1A-1C show SEM-BSD images of a sintered multi-doped LLZO with Al doping greater than about 0.15 pfu (i.e., Li_{6.55}Al_{0.15}La₃Zr₂O₁₂). FIG. 1A shows a cross-section 101 of the sintered multi-doped LLZO. FIG. 1B shows the LLZO surface 103 exposed during sintering. FIG. 1C shows the elemental mapping of Al using SEM-energy dispersive X-ray spectroscopy (EDS), depicting areas 105 of concentrated Al for the same region shown in FIG. 1B. In each of these cases, lithium dendrites have been shown to propagate along Al-rich regions in grain boundaries. Moreover, the non-uniform size of the grains in the cross-section shown in FIG. 1C is indicative of abnormal grain growth, which can result from the incorporation of too much sintering aid. This results in significant secondary phases in the grain boundaries, which are electrochemically susceptible to reactions and dendrite propagation. Moreover, these microstructures are also mechanically weaker. It is therefore desirable to control the aluminum content to be less than about 0.24 pfu, or less than about 0.15 pfu and greater than 0.0 pfu.

In many cases, Al is introduced to the LLZO material during calcination or sintering by the use of Al₂O₃-rich crucibles, which are reactive towards LLZO. For example, when using a pure Al₂O₃ crucible during calcination, up to about 0.24 Al pfu or more can be added to the LLZO. The amount of Al cannot be strictly controlled by this type of process. Instead, in some embodiments, addition of controlled amounts of Al may be accomplished by using the desired amount of Al-containing precursor material before calcination, and calcining and/or sintering on a substrate that comprises less than about 5% Al₂O₃.

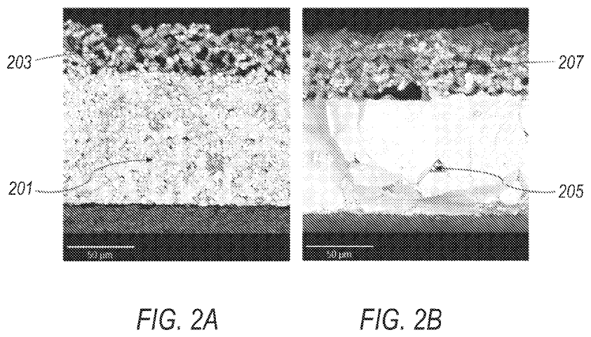

FIGS. 2A and 2B shows the impact of less than about 0.15 pfu Al on the microstructure of a sintered multi-doped LLZO with and without Al. In FIG. 2A, the LLZO bilayer was sintered without Al doping. The cross-section of the dense layer 201, below porous layer 203, can be seen in FIG. 2A as having a granular, less-dense structure after sintering. In contrast, FIG. 2B shows a cross-section of Al-doped LLZO dense layer 205, below porous layer 207, having improved density with significantly less granular formations. The presence of Al at less than about 0.15 pfu (e.g., less than about 0.12 pfu, less than about 0.10 pfu, or from about 0.01 pfu to about 0.08 pfu), significantly improves the densification and lowers the porosity of the sintered LLZO without the formation of unstable secondary phases. In the solid-state electrolyte of FIG. 2B aluminum is present in an amount of 0.05 pfu.

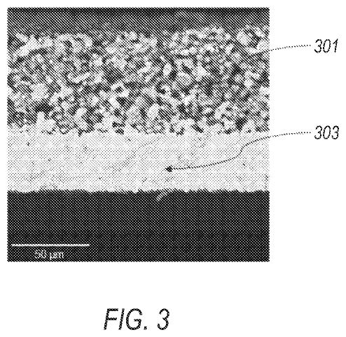

FIG. 3 shows an SEM-BSD cross-section of a sintered multi-doped LLZO having a bilayer configuration of porous layer 301 and dense layer 303, where the LLZO is doped with less than about 0.1 pfu of Al, less than about 0.3 pfu and greater than about 0.1 pfu of Ca, and greater than about 0.4 pfu and less than about 0.6 pfu of Ta. Advantageously, the sintered multi-doped LLZO in FIG. 3 was prepared without the use of a powder bed.

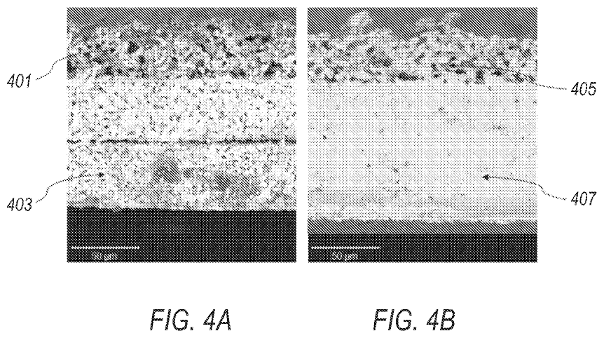

FIGS. 4A and 4B are images of cross-sections of the sintered multi-doped LLZO of Examples 1 and 2. Both sintered multi-doped LLZO materials were prepared without a powder bed. In FIG. 4A, the sintered multi-doped LLZO of Example 1 is shown with porous layer 401 and dense layer 403. As can be seen, dense layer 403 is noticeably porous. Importantly, LLZO cannot properly sinter and densify if the lithium lost during sintering causes a lithium deficiency in the LLZO composition. A lithium deficiency can arise when the lithium present is less than the stoichiometric amount, and/or when the lithium loss prevents formation of a stable cubic phase during calcination and/or sintering. Generally, a loss of over about 1% of lithium from the initial quantity can lead to a lithium deficiency.

FIG. 4B shows the sintered multi-doped LLZO of Example 2 with porous layer 405 and dense layer 407. As can be seen, the dense layer 407 has very low porosity and was fully sintered without the use of a powder bed. The ability to sinter effectively without the use of a powder bed demonstrates the potential benefits the solid-state electrolyte materials described herein.

### Conductivity of Solid-State Electrolyte Materials:

The sintered solid-state electrolyte materials of Examples 1 and 2 were tested for conductivity. Au electrodes were sputtered onto both sides of each sintered solid-state electrolyte material. Ag-paste was used to adhere Ag wire contacts. Electrochemical impedance spectroscopy was used to analyze the impedance response of the sintered solid-state electrolyte materials over a frequency range of 1 MHz to 100 Hz to determine the ionic conductivity. The ionic conductivity was measured to be 2.2 mS/cm for the sintered solid-state electrolyte of Example 1. The sintered solid-state electrolyte material of Example 2 exhibited an ionic conductivity of 4.2 mS/cm.

### X-Ray Diffraction Analysis:

Compositions such as those described herein can be checked for quality after the blending and calcining processes by, for example, inductively coupled plasma, x-ray diffraction (XRD), and loss on ignition. Preferably, the resulting powder after calcination is uniform in composition, has the desired crystalline phase purity as determined by XRD, has negligible remaining unreacted components such as hydroxides and carbonates (evaluated by measuring the loss on ignition), and has the desired elemental composition as determined by inductively coupled plasma.

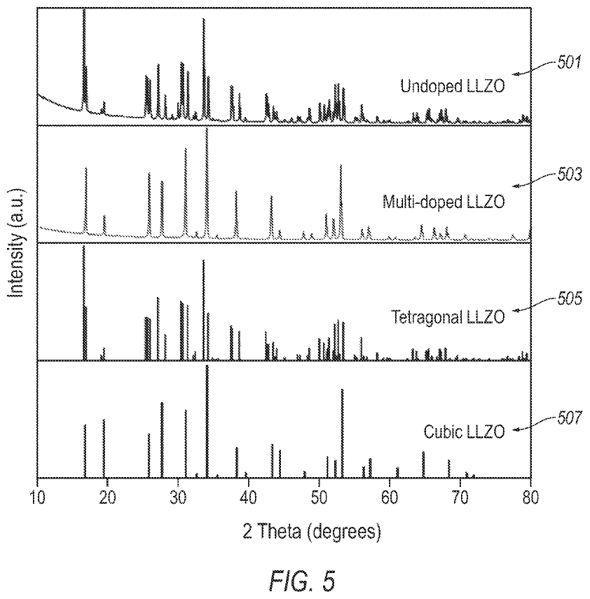

FIG. 5 depicts reference XRD spectra for cubic LLZO 507 and tetragonal LLZO 505, as well as measured results for as-calcined multi-doped LLZO 503 (i.e., the calcined composition of Example 2), and as-calcined undoped LLZO 501. The multi-doped and undoped LLZO were blended and calcined as described above. As shown in FIG. 5, the multi-doped LLZO 503 matches the high Li⁺ conductivity cubic phase 507 well, while the undoped LLZO 501 matches the low conductivity tetragonal phase 505.

### Battery Cell

In some embodiments of the present approach, the sintered electrolyte may be incorporated into a battery cell as a ceramic separator or host structure for lithium metal plating, or both. The sintered electrolyte physically contacts a cathode material and anode material to form a combined electrode pair and separator layer of the battery. These layers may be optionally stacked with anode current collectors contacting the anode surface opposite the solid electrolyte separator and cathode current collectors contacting the anode surface opposite the solid electrolyte separator to form a cell. This battery cell may be incorporated into a wide variety of applications including but not limited to electric vehicles.

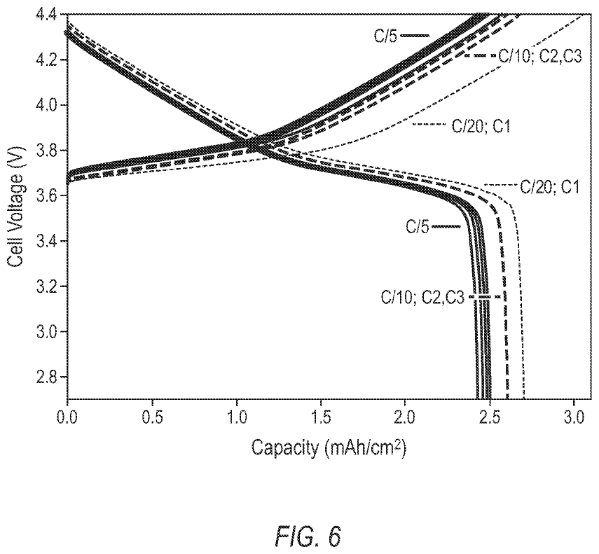

A battery cell comprising a multi-doped LLZO ceramic bilayer separator according to Example 2 was made utilizing an anode (lithium metal) and a cathode (lithium nickel manganese cobalt oxide (NMC)). FIG. 6 shows the voltage profiles of the battery cell as a function of capacity as the cell is charged and discharged at C/20 (1^{st} cycle), C/10 (cycles 2-3), and C/5 (cycles 4-7). The high coulombic efficiency, evidenced by the very similar charge and discharge capacity for each cycle, is indicative of a high performing cell.

### EQUIVALENTS AND SCOPE

In the claims articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention includes embodiments in which more than one, or all of the group members are present in, employed in, or otherwise relevant to a given product or process.

Furthermore, the invention encompasses all variations, combinations, and permutations in which one or more limitations, elements, clauses, and descriptive terms from one or more of the listed claims is introduced into another claim. For example, any claim that is dependent on another claim can be modified to include one or more limitations found in any other claim that is dependent on the same base claim. Where elements are presented as lists, e.g., in Markush group format, each subgroup of the elements is also disclosed, and any element(s) can be removed from the group. It should it be understood that, in general, where the invention, or aspects of the invention, is/are referred to as comprising particular elements and/or features, certain embodiments of the invention or aspects of the invention consist, or consist essentially of, such elements and/or features. For purposes of simplicity, those embodiments have not been specifically set forth in haec verba herein. It is also noted that the terms “comprising” and “containing” are intended to be open and permits the inclusion of additional elements or steps. Where ranges are given, endpoints are included. Furthermore, unless otherwise indicated or otherwise evident from the context and understanding of one of ordinary skill in the art, values that are expressed as ranges can assume any specific value or sub-range within the stated ranges in different embodiments of the invention, to the tenth of the unit of the lower limit of the range, unless the context clearly dictates otherwise.

This application refers to various issued patents, published patent applications, journal articles, and other publications, all of which are incorporated herein by reference. If there is a conflict between any of the incorporated references and the instant specification, the specification shall control. In addition, any particular embodiment of the present invention that falls within the prior art may be explicitly excluded from any one or more of the claims. Because such embodiments are deemed to be known to one of ordinary skill in the art, they may be excluded even if the exclusion is not set forth explicitly herein. Any particular embodiment of the invention can be excluded from any claim, for any reason, whether or not related to the existence of prior art.

Those skilled in the art will recognize or be able to ascertain using no more than routine experimentation many equivalents to the specific embodiments described herein. The scope of the present embodiments described herein is not intended to be limited to the above Description, but rather is as set forth in the appended claims. Those of ordinary skill in the art will appreciate that various changes and modifications to this description may be made without departing from the spirit or scope of the present invention, as defined in the following claims.

What is claimed is:

1. A solid-state electrolyte material comprising a composition of Formula (I):
M1₇₋ₓD1ₐM2_{3-y}D2_{b}M3_{2-z}D3_{c}O_{12-w}D4_{d} (I),
wherein:
M1 is Li;
M2 is La;
M3 is Zr;
D1 is H, Be, B, Al, Fe, Zn, Ga, Ge, or any combination thereof;
D2 is Na, K, Ca, Rb, Sr, Y, Ag, Ba, Bi, Pr, Nd, Pm, Sm, Gd, Tb, Dy, Ho, Er, Tm, Zn, Ce, or any combination thereof;
D3 is Mg, Si, Sc, Ti, V, Cr, Mn, Co, Ni, Cu, Ge, As, Se, Nb, Mo, Tc, Ru, Rh, Pd, Cd, In, Sn, Sb, Hf, Ta, W, Ir, Pt, Au, Hg, Tl, Pb, Ce, Eu, Te, Y, Sr, Ca, Ba, Gd, Ge, or any combination thereof;
D4 is F, Cl, Br, I, S, Se, Te, N, P, or any combination;
0≤w≤2;
−0.5<x≤3;
0≤y≤3;
0≤z≤2;
0≤a≤2;
0≤b≤3;
0≤c≤2; and
0≤d≤2,
wherein at least one of a, b, c, and d is not zero.

2. The solid-state electrolyte material of claim 1, wherein
0<y≤3,
0<z≤2,
0<a≤2,
0<b≤3, and
0<c≤2.

3. The solid-state electrolyte material of claim 1 or 2, wherein 0≤w≤1.

4. The solid-state electrolyte material of any one of claims 1-3, wherein 0≤w≤0.5.

5. The solid-state electrolyte material of any one of claims 1-4, wherein 0≤w≤0.1.

6. The solid-state electrolyte material of any one of claims 1-5, wherein 0≤x≤1.

7. The solid-state electrolyte material of any one of claims 1-6, wherein 0.2≤x≤0.8.

8. The solid-state electrolyte material of any one of claims 1-7, wherein 0<y<3.

9. The solid-state electrolyte material of any one of claims 1-8, wherein 0<y<1.

10. The solid-state electrolyte material of any one of claims 1-9, wherein 0<y<0.5.

11. The solid-state electrolyte material of any one of claims 1-10, wherein 0.05≤y≤0.25.

12. The solid-state electrolyte material of any one of claims 1-11, wherein 0<a≤1.

13. The solid-state electrolyte material of any one of claims 1-12, wherein 0<a<0.24.

14. The solid-state electrolyte material of any one of claims 1-13, wherein 0<b<3.

15. The solid-state electrolyte material of any one of claims 1-14, wherein 0<b<1.

16. The solid-state electrolyte material of any one of claims 1-15, wherein 0<b<0.5.

17. The solid-state electrolyte material of any one of claims 1-16, wherein 0.05≤b≤0.25.

18. The solid-state electrolyte material of any one of claims 1-17, wherein 0<c≤0.7.

19. The solid-state electrolyte material of any one of claims 1-18, wherein 0<c≤0.5.

20. The solid-state electrolyte material of any one of claims 1-19, wherein 0.2≤c≤0.5.

21. The solid-state electrolyte material of any one of claims 1-20, wherein 0≤d≤1.

22. The solid-state electrolyte material of any one of claims 1-21, wherein 0≤d≤0.5.

23. The solid-state electrolyte material of any one of claims 1-22, wherein 0≤d≤0.1.

24. The solid-state electrolyte material of any one of claims 1-23, wherein D1 is Al, Fe, Zn, and Ga, or any combination thereof.

25. The solid-state electrolyte material of any one of claims 1-24, wherein D2 is Ca, Sr, Ba, Bi, and Nd, or any combination thereof.

26. The solid-state electrolyte material of any one of claims 1-25, wherein D3 Ta, Nb, W, Ti, and Mo, or any combination thereof.

27. The solid-state electrolyte material of claim 1, wherein
7−x=7−a(vD1)+b(3−vD2)+c(4−vD4)−d/2, wherein vD1 is an oxidation state of D1, vD2 is an oxidation state of D2, and vD3 is an oxidation state of D3;
D4 is F, Cl, Br, I, or any combination thereof;
y=b;
z=c; and
w=d.

28. The solid-state electrolyte material of claim 27, wherein 0≤x≤1.0.

29. A solid-state electrolyte material comprising a composition of Formula (II):
Li₇₋ₓD1ₐLa_{3-y}D2_{b}Zr_{2-z}D3_{c}O_{12-w}D4_{d} (II),
wherein:
D1 is H, Be, B, Al, Fe, Zn, Ga, Ge, or any combination thereof;
D2 is Na, K, Ca, Rb, Sr, Y, Ag, Ba, Bi, Pr, Nd, Pm, Sm, Gd, Tb, Dy, Ho, Er, Tm, Zn, Ce, or any combination thereof;
D3 is Mg, Si, Sc, Ti, V, Cr, Mn, Co, Ni, Cu, Ge, As, Se, Nb, Mo, Tc, Ru, Rh, Pd, Cd, In, Sn, Sb, Te, I, Hf, Ta, W, Ir, Pt, Au, Hg, Tl, Pb, Ce, Eu, Te, Y, Sr, Ca, Ba, Gd, Ge, or any combination thereof;
D4 is F, Cl, Br, I, S, Se, Te, or any combination thereof;
0≤w<2;
−0.5<x≤3;
0<y≤3;
0<z≤2;
0<a≤2;
0<b≤3; 0<c≤2; and
0≤d≤2.

30. The solid-state electrolyte material of claim 29, wherein 0≤w≤1.

31. The solid-state electrolyte material of claim 29 or 30, wherein 0≤w≤0.5.

32. The solid-state electrolyte material of any one of claims 29-31, wherein 0≤w≤0.1.

33. The solid-state electrolyte material of any one of claims 29-32, wherein 0<x≤1.5.

34. The solid-state electrolyte material of any one of claims 29-33, wherein 0.5<y<2.

35. The solid-state electrolyte material of any one of claims 29-34, wherein 0.5<z≤1.5.

36. The solid-state electrolyte material of any one of claims 29-35, wherein 0<a<0.24.

37. The solid-state electrolyte material of any one of claims 29-36, wherein 0<b≤2.

38. The solid-state electrolyte material of any one of claims 29-37, wherein 0<c≤1.5.

39. The solid-state electrolyte material of any one of claims 29-38, wherein 0≤d≤1.

40. The solid-state electrolyte material of any one of claims 29-39, wherein 0≤d≤0.5.

41. The solid-state electrolyte material of any one of claims 29-40, wherein 0≤d≤0.1.

42. The solid-state electrolyte material of claim 29, wherein:
D1 is Al, Ga, or any combination thereof;
D2 is Ca, Sr, Ba, or any combination thereof;
D3 is Ta, Nb, W, Ti, Mo, or any combination thereof; and
D4 is F, Cl, or any combination thereof.

43. The solid-state electrolyte material of claim 42, wherein 0<a≤0.25.

44. The solid-state electrolyte material of claim 42 or 43, wherein 0<b≤0.5.

45. The solid-state electrolyte material of any one of claims 42-44, wherein 0<c≤1.0.

46. The solid-state electrolyte material of any one of claims 42-45, wherein 0≤d≤0.25.

47. The solid-state electrolyte material of any one of claims 42-46, wherein 0≤x≤1.0.

48. The solid-state electrolyte material of any one of claims 42-47, wherein 0≤y≤0.5.

49. The solid-state electrolyte material of any one of claims 42-48, wherein 0≤z≤1.0.

50. The solid-state electrolyte material of any one of claims 42-49, wherein 0≤w≤0.25.

51. The solid-state electrolyte material of claim 29, wherein
7−x=7−a(vD1)+b(3−vD2)+c(4−vD4)−d/2, wherein vD1 is an oxidation state of D1, vD2 is an oxidation state of D2, and vD3 is an oxidation state of D3;
D4 is F, Cl, Br, I, or any combination thereof;
y=b;
z=c; and
w=d.

52. The solid-state electrolyte material of claim 51, wherein 0≤x≤1.0.

53. A solid-state electrolyte material comprising a composition of Formula (IV):
LiₙBₓ^{vB}La_{3-y}C_{y}^{vC}Zr_{2-z}D_{z}^{vD}O₁₂₋ₐGₐ (IV),
wherein:
n=7−x(vB)+y(3−vC)+z(4−vD)−a/2, wherein vB is an oxidation state of B, vC is an oxidation state of C, and vD is an oxidation state of D;
B is H⁺, Al³⁺, Ga³⁺, Fe³⁺, Zn²⁺, Ge⁴⁺, or any combination thereof;
C is Ca²⁺, Ba²⁺, Sr²⁺, Mg²⁺, Rb⁺, Ce⁴⁺, or any combination thereof;
D is Ta⁵⁺, Y³⁺, Mo⁶⁺, Nb⁵⁺, W⁶⁺, Ge⁴⁺, Ti⁴⁺, or any combination thereof;
G is F⁻, Cl⁻, Br⁻, I⁻, or any combination thereof;
0<x<0.24;
0<y≤1.0;
0<z≤1.0; and
0≤a≤1.0.

54. The solid-state electrolyte material of claim 53, wherein B is Al³⁺.

55. The solid-state electrolyte material of claim 53 or 54, wherein C is Ca²⁺.

56. The solid-state electrolyte material of any one of claims 53-55, wherein D is Ta⁵⁺, Nb⁵⁺, Ti⁴⁺, or any combination thereof.

57. The solid-state electrolyte material of any one of claims 53-56, wherein D is Ta⁵⁺.

58. The solid-state electrolyte material of any one of claims 53-57, wherein 0<x<0.15 at least one of 0<x<0.15; 0<y<0.50; and 0<z<0.70.

59. The solid-state electrolyte material of any one of claims 53-58, wherein 0.02<x<0.10.

60. The solid-state electrolyte material of any one of claims 53-59, wherein 0<y<0.50.

61. The solid-state electrolyte material of any one of claims 53-60, wherein 0.1<y<0.30.

62. The solid-state electrolyte material of any one of claims 53-61, wherein 0.15<y<0.28.

63. The solid-state electrolyte material of any one of claims 53-62, wherein 0<z<0.70.

64. The solid-state electrolyte material of any one of claims 53-63, wherein 0.3<z<0.6.

65. The solid-state electrolyte material of any one of claims 53-64, wherein 0.4<z<0.55.

66. The solid-state electrolyte material of any one of claims 53-65, wherein 0≤a<0.1.

67. The solid-state electrolyte material of any one of claims 53-66, wherein 0≤a<0.05.

68. The solid-state electrolyte material of claim 53, wherein x, y, z, and a are selected such that 6≤n≤7.

69. A solid-state electrolyte material comprising a composition of Formula (V):
Li₇₋ₓBₐLa_{3-y}C_{b}Zr_{2-z}D_{c}O₁₂ (V),
wherein:
B is Al or Ga;
C is Ca, Sr, Ba, or Mg;
D is Ta, Nb, W, Mo, or Ti;
0≤x≤1;
0<a<0.24;
0<y≤0.5;
0<b≤0.5;
0<z≤1; and
0<c≤1.

70. A solid-state electrolyte material comprising a composition of Formula (VI):
Li_{7+y-z}La_{3-y}Ca_{y}Zr_{2-z}Ta_{z}O₁₂ (VI),
wherein:
0<y<0.3; and
0.2<z<0.6.

71. A solid-state electrolyte material comprising a composition of Formula (VII):
Li_{7-3x+y-z}AlₓLa_{3-y}Ca_{y}Zr_{2-z}Ta₂O₁₂ (VII),
wherein:
0<x<0.15;
0<y<0.3; and
0.2<z<0.6.

72. A solid-state electrolyte material comprising a composition of Formula (VIII):
Li_{7-3x+y-z}BₓLa_{3-y}Ca_{y}Zr_{2-z}Ta_{z}O₁₂ (VIII),
wherein:
B is Al;
0≤x<0.25;
0<y≤0.5; and
0<z≤1.

73. The solid-state electrolyte material of claim 72, wherein 0≤x<0.15.

74. The solid-state electrolyte material of claim 72, wherein x is 0.

75. The solid-state electrolyte material of claim 72, wherein 0<x<0.25.

76. The solid-state electrolyte material of claim 72, wherein 0<y<0.3.

77. The solid-state electrolyte material of claim 72, wherein 0.2<z<0.6.

78. A bilayer solid-state electrolyte structure, comprising
a porous layer; and
a dense layer
wherein at least one of the porous layer and the dense layer comprises the solid-state electrolyte material of any one of claims 1-77.

79. A trilayer solid-state electrolyte structure, comprising
a first porous layer;
a dense layer; and
a second porous layer
wherein at least one of the first porous layer, the dense layer, and the second porous layer comprises the solid-state electrolyte material of anyone one of claims 1-77.

80. The solid-state electrolyte material of any one of claims 1-77, wherein the solid-state electrolyte material is sintered.

81. A solid-state battery comprising an electrolyte material of any of claims 1-77.

82. The solid-state battery of claim 81, wherein the electrolyte material is sintered.

83. The solid-state battery of claim 82, wherein the sintered electrolyte material is incorporated into a ceramic separator.

84. The solid-state battery of claim 82, wherein the sintered electrolyte material is incorporated into a host structure for lithium metal plating and stripping.

85. The solid-state battery of claim 82, wherein the sintered electrolyte material is in physical contact with a cathode material and anode material, forming a combined electrode pair and separator layer.

86. A method for forming a green body, the method comprising:
(a) reacting a precursor mixture to form a solid-state electrolyte material of any one of claims 1-77;
(b) dispersing the solid-state electrolyte material in a solvent to form a dispersed material;
(c) mixing a first portion of the dispersed material with a first binder and a first plasticizer to form a dense mixture;
(d) mixing a second portion of the dispersed material with a second binder, a second plasticizer, and a pore-forming agent to form a porous mixture;
(e) casting the dense mixture on a first substrate to form a dense cast tape;
(f) casting the porous mixture on a second substrate to form a porous cast tape;
(g) drying the dense cast tape and the porous cast tape; and
(h) laminating the dense cast tape with the porous cast tape to form the green body.

87. The method of claim 6, further comprising adding a lithium-donating compound to at least one of the dispersed material, the dense mixture, and the porous mixture.

88. The method of claim 86, wherein the reacting step (a) comprises calcining the precursor mixture.

89. The method of claim 88, wherein the calcining is performed in a heated crucible.

90. The method of claim 86, wherein the reacting step (a) further comprises
(a-1) reacting a precursor mixture to form a solid-state electrolyte material; and
(a-2) milling the solid-state electrolyte material to increase uniformity and reduce particle size.

91. The method of claim 86, further comprising de-aerating at least one of the dense mixture and the porous mixture under vacuum.

92. The method of claim 86, wherein the laminating step (h) comprises
(h-1) stacking the porous cast tape and the dense cast tape; and
(h-2) passing the stacked tapes through a heated roller press.

93. The method of claim 86, wherein the laminating step is repeated to form a multilayer green body.

94. A method of forming a sintered solid-state electrolyte, the method comprising
forming a green body according to a method of any one of claims 86-93; and
sintering the green body to form the sintered solid-state electrolyte.
